(19) United States
(12) Patent Application Publication
(10) Pub. No.: US 2010/0119376 A1
(43) Pub. Date: May 13, 2010

(54) INLET CONE FOR JET ENGINE

(75) Inventors: Thomas Uihlein, Dachau (DE); Markus Uecker, Munich (DE); Olivier Seite, Montreal (CA)

Correspondence Address: HOWISON & ARNOTT, L.L.P, P.O. BOX 741715, DALLAS, TX, 75374-1715, US

(73) Assignee: MTU AERO ENGINES GMBH, Munich (DE)

(21) Appl. No.: 12/442,520

(22) PCT Filed: Sep. 18, 2007
(86) PCT No.: PCT/DE07/01683

§ 371 Date: Dec. 16, 2009

(30) Foreign Application Priority Data
Sep. 23, 2006 (DE) 10 2006 044 968.1

(51) Int. Cl. B64C 11/14

(52) U.S. Cl. 416/245 R

(57) ABSTRACT

Inlet cone (1) for a jet engine (10) configured as a bypass turbojet engine, which has an engine core area (11) and a casing area (12) that surrounds it, whereby the inlet cone (1) is placed concentrically in the air inlet area of the jet engine (10) and placed on a turnably supported shaft (14), whereby the inlet cone (1) has a conical angle (15) at which solid bodies (16) impinging with the air flow onto the inlet cone (1) ricochet off it in motion paths (17) which lead most of the solid bodies (16) into the casing area (12). Thereby an inlet cone (1) is created in which the entry of solid bodies 16 into the engine core area (11) can be minimized.

### CROSS-REFERENCE TO RELATED APPLICATIONS

This application is a U.S. National Phase application submitted under 35 U.S.C. §371 of Patent Cooperation Treaty application serial no. PCT/DE2007/001683, filed Sep. 18, 2007, and entitled EINTRITTSKONUS FÜR EIN STRAHLTRIEBWERK, which application claims priority to German patent application serial no. DE 10 2006 044 968.1, filed Sep. 23, 2006, and entitled EINTRITTSKONUS FÜR EIN STRAHLTRIEBWERK, the specifications of which are incorporated herein by reference in their entireties.

### TECHNICAL FIELD

The present invention relates to an inlet cone for a jet engine configured as a bypass turbojet engine, which has a casing area that surrounds it, whereby the inlet cone is placed concentrically in the air intake area and is placed on a turnable shaft.

### BACKGROUND

A generic cone configuration is known from European patent text EP 0 294 654 B1. The outer shape of the cone configuration corresponds to that of a paraboloid of rotation. To form a flange for attachment, the wall of the cone configuration is drawn inward, so that in case a foreign body strikes the cone configuration, it remains undamaged owing to a special formation in the flange connection area onto the rotor. However, the flight path of the foreign body that impinges on the cone configuration cannot be controlled. Especially owing to configuring the outer form as a paraboloid of rotation, it is not possible to predict the flight path direction of the cone configuration after the ricocheting.

A cone configuration is known from U.S. patent application 2006/0056977 A1, which is movable along the longitudinal axis of the jet engine. According to the arrangement disclosed herein, the cone configuration can be lifted from the low-pressure turbine shaft, counter to the flow direction, so that an optimal flow in the entry area of the jet engine can be created and is adaptable to various flight conditions of the flight vehicle. Additionally, the proposed mobility of the cone configuration in the direction of the longitudinal axis should offer effective protection against the formation of ice and against impinging solid bodies.

In fact a check of the impingement angle of the entering fluid is possible, but the proposed embodiment involves considerable design expense. No guarantee is provided that the jet engine, and particularly the engine core area, is protected against impinging solid bodies.

Especially in high pressure compressors, i.e. in the engine core area, sand accumulation leads to erosion of the components, since sand hits their surfaces at high relative velocity. In the casing area, impinging solid bodies like sand do not cause substantial damage, because the impinging air is subject to markedly less acceleration and undergoes no thermal alteration owing to densification and fuel combustion which takes place only in the engine core area. Along with blocking the cooling gaps, in the jet engine the sand further triggers a considerable erosion, since sulfates found in the sand reveal an interaction with the components of the jet engine. This problem can only be minimized by minimizing the entry of solid bodies like sand and the like into the engine core area if possible.

An inlet cone 1 according to the state of the art is shown in FIG. 4, which is placed on the front end of a low-pressure turbine shaft 14 of a jet engine 10. The jet engine 10 has an engine core area 11 as well as a casing area 12. The inlet cone 1 is placed concentrically to the longitudinal axis 13 and has a flat conical angle 15. The flat or small conical angle 15 causes most solid bodies 16 impinging on the cone 1 to get into the engine core area 11 after ricocheting off the surface of cone 1. After ricocheting off cone 1, the solid bodies move along various movement paths 17, whereby the movement paths 17a get into the engine core area and the movement paths 17b get into the casing area. According to the depiction in FIG. 4, a majority of solid bodies 16 are guided into the engine core area. By this means, the engine core area 11 suffers considerable damage, since the solid bodies trigger an especially severe erosion in the engine core area. Particularly, the sulfates found in sand, and the accompanying sulfidation, represent one of the limiting damage mechanisms for the low pressure turbines.

### SUMMARY

Therefore, it is the task of the present invention to produce an inlet cone for a jet engine in which the entry of solid bodies into the engine core area can be minimized in a checkable manner.

This problem is solved by the features as claimed. Advantageous further embodiments of the invention are given in the dependent claims.

The invention includes the technical teaching that the inlet cone is characterized by a conical angle at which, with the air flow, solid bodies impinging on the cone configuration ricochet off the cone configuration, which leads most of the solid bodies into the casing area.

The invention offers the advantage in that through a suitably selected conical angle, the particle paths of the impinging solids are modified by modifying the ricochet angle and the air flow, especially over the entire cone configuration in such a way that most of the impinging solid bodies, such as sand particles, get into the casing area. With a reduced share of solid bodies entering the engine core area, the damage mechanisms connected therewith are minimized. Owing to an obtuse inlet cone, fewer solid bodies get into the engine core area than with an acute cone. Most of the particles thus get into the bypass flow, i.e., into the casing area. They have considerably less erosive and corrosive effects there.

According to an advantageous embodiment of the cone configuration, it is suggested that the conical angle of the cone arrangement have a value from 30° to 45°, preferably from 35° to 40°, and especially preferred at 38°. Especially an angle of about 38°, as half the angle of the wedge-shaped cone configuration, has proven to be especially advantageous, because at this angle only a very small share of the solid bodies that impinge altogether on the cone configuration, penetrate into the engine core area. Nonetheless, with a conical angle of 38°, an ideal air flow remains that enters the jet engine.

According to a further advantageous embodiment of the invention, the cone configuration can be divided into an inner inflow region and an outer inflow region, and the radial boundary between the regions is defined by a limit flow radius. Thus the solid bodies that impinge with the air flow into the inner inflow region, after ricocheting off the cone configuration, get via an inner motion path into the engine core area and the solid bodies get via an outer motion path, after ricocheting, into the casing area. The limit flow radius has a radial share of 50% to 70%, preferably of 55% to 65%, and especially preferred on 62% of the exterior radius of the cone configuration. This means that within a radial share of 62% of the overall radius of the cone configuration, the impinging solid bodies follow, at a richochet angle, those motion paths that lead into the casing area. Only the remaining radial area in the outer region of the cone, thus about a radial share of 38%, cause the solid bodies to penetrate into the engine core area, which compared to the share as per the state of the art, corresponds to an improvement of about 40%. This means that 40% less sand gets into the engine core area.

According to a further advantageous embodiment form of a cone configuration, it extends over the entire length of the cone configuration in the extension direction of the longitudinal axis with a uniform conical angle. With this, the outer side of the cone configuration passes in stageless fashion into the area of the fan blades, so that an uninterrupted flow contour is formed.

According to a further embodiment example, provision is made that the cone configuration in the inner inflow area has a larger conical angle than in the outer inflow area, so that the angular kink of the differing conical angles coincides with the limit flow radius. By means of the differing ascents of the cone, it can be lengthened, which makes possible a further optimization and reduction in the solid bodies entering the engine core area. According to this embodiment example, the cone configuration is embodied in such a way that it exhibits a steep angle in the upward flow direction, whereupon a flat conical angle follows in the flow direction, that makes a transition into the blade arrangement.

The area in which the conical angle changes can advantageously be in the limit flow radius, so that the solid bodies that impinge on the front, steeper conical area, are all led into the casing area, whereupon only a small share in the outer conical area bordering on the blade arrangement results in the solid bodies getting into the engine core area. Thus what is advantageously attained is that the share of sand particles getting into the casing area is from 50% to 70%, preferably from 55% to 65%, and especially preferred, 62% of all the sand particles impinging on the cone configuration. With a corresponding alteration of the cone configuration, however, a greater share can be attained of sand particles entering into the casing area.

In addition, the present invention relates to use of a cone configuration for a jet engine configured as a bypass turbojet engine, that has an engine core area and a casing area that surrounds it, whereby the cone configuration is placed centrally in the air intake area of the jet engine, and in front is placed on a low pressure turbine shaft supported so as to be turnable about a longitudinal axis, and whereby the cone configuration has a conical angle with a value of 30° to 45°, preferably from 35° to 40°, and especially preferred at 38°, at which the solid bodies impinging with the air flow onto the cone configuration ricochet from the cone configuration on motion paths that lead most of the solid bodies into the casing area.

### BRIEF DESCRIPTION OF THE DRAWINGS

Further measures that improve the invention are indicated in the accompanying claims, or will be depicted in what follows in greater detail along with the description of a preferred embodiment example of the invention with the aid of the figures.

Shown are:

FIG. 1 illustrates an inlet cone of a jet engine with a conical angle according to the present invention;

FIG. 2 illustrates a schematic depiction of the cone as well as of the engine core area and the casing area;

FIG. 3 illustrates a schematic top-down view of the inlet cone, which is dividable into an inner inflow region and an outer inflow region;

FIG. 4 illustrates an inlet cone of a jet engine as per the state of the art.

### DETAILED DESCRIPTION

Referring now to the drawings, the various views and embodiments of an inlet cone for a jet engine are illustrated and described, and other possible embodiments are described.

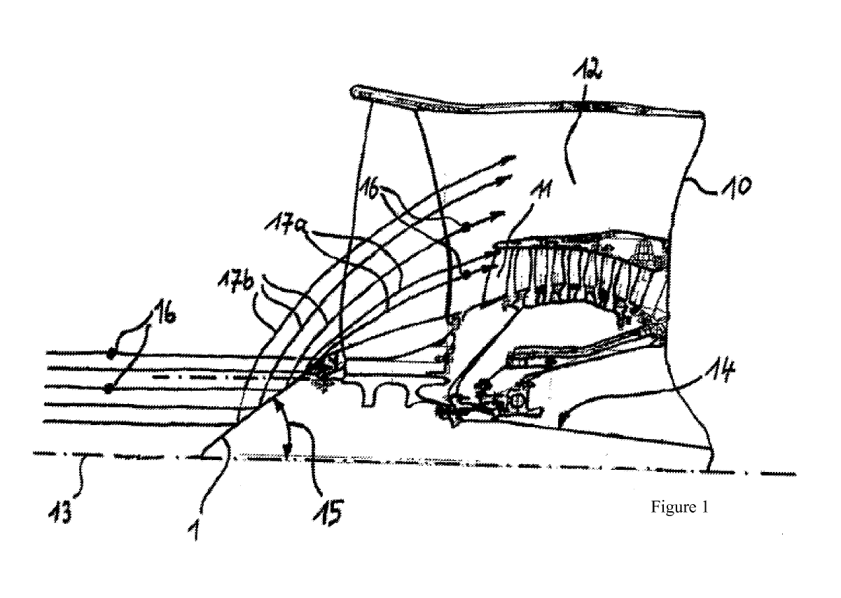

The inlet cone depicted in FIG. 1 is provided with reference number 1. This is located in the front in the flow direction on a jet engine 10, and is placed concentric with a longitudinal axis 13. The inlet cone 1 is mounted on a low pressure turbine shaft 14, so that the inlet cone 1 rotates with the turbine shaft. The jet engine 10 can be divided into an inner engine core area 11 and an outer casing area 12.

As examples, solid bodies 16 are depicted that move along various movement paths 17. The movement paths are divided into those that terminate in the engine core area 11, and these are designated with the reference number 17a, while the movement paths 17 that terminate in the casing area 12, are provided with the reference number 17b. Along with the air flow running parallel to longitudinal axis 13, the solid bodies 16 impinge on inlet cone 1. After the impingement, the solid bodies 16 ricochet off cone 1 and move along the depicted movement paths 17a and 17b. According to the present invention, cone 1 is configured with a conical angle 15 that has a value so constituted that solid bodies 16 that impinge with the air flow on cone 1 follow motion paths 17b moving away from cone 1, that lead most of the solid bodies 16 into the casing area 12. In contrast, only a small share of the solid bodies 16 move along motion paths 17a that lead into the engine core area 11.

FIG. 2 is a schematic depiction of the arrangement of the cone as well as of the engine core area 11 and of the casing area 12. The longitudinal axis 13 is shown schematically as bisecting, so that cone 1 extends relative to longitudinal axis 13 at the conical angle 15. The separation between engine core area 11 and casing area 12 is depicted schematically by a partition. The solid bodies 16 impinge on the inlet cone 1. After ricocheting, the solid bodies 16 move along inner and out motion paths 17a and 17b. The solid bodies 16 that move along inner motion path 17a into the engine core area 11, first impinge in the outer inflow region 19 onto inlet cone 1. The solid bodies 16 that move along outer motion paths 17b into the casing area 12, impinge on cone 1 in the inner inflow region 18. The boundary between inner inflow region 18 and outer inflow region 19 is given by the limit flow radius 20, whereby inner inflow region 18 has the larger radial share and only a smaller outer inflow radius 19 is present.

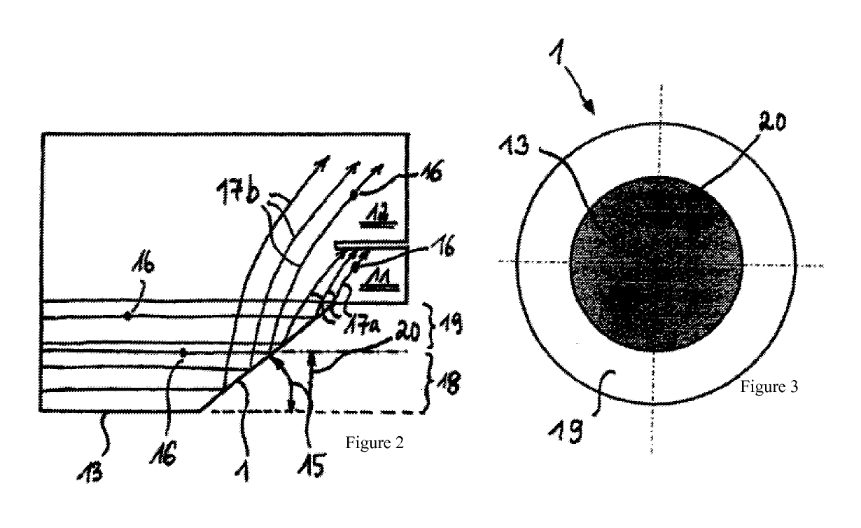

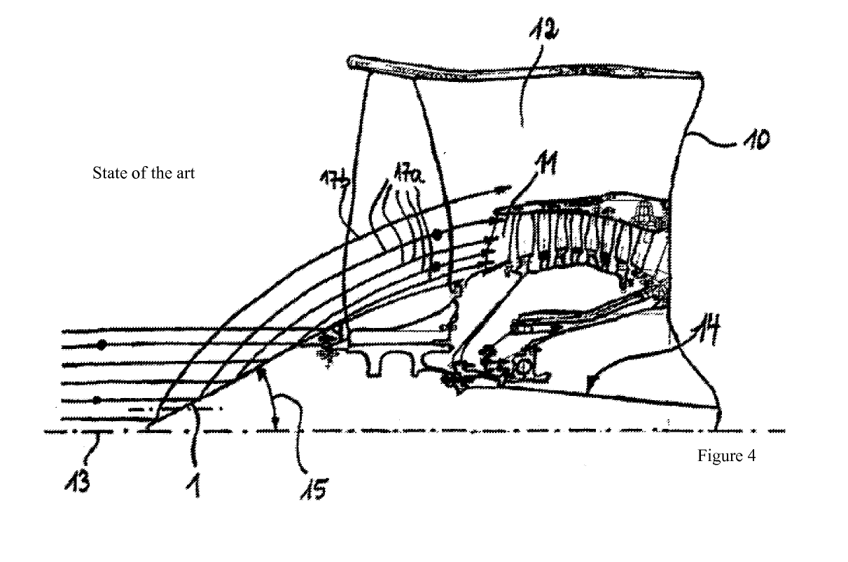

FIG. 3 is a schematic representation of a top-down view of entry cone 1 as a direction of longitudinal axis 13. The limit flow radius 20 limits the inner inflow region 18, while in contrast the outer inflow region 19 extends out to the outer radius of inlet cone 1. The large area that inner inflow region 18 forms is easily perceptible, so that solid bodies impinging onto this surface are merely passed into casing area 12, while in contrast the smaller outer inflow area 19 allows impingement of the solid bodies into the engine core area. The share of limit flow radius 20 in relation to the overall radius of cone configuration 1 is about 62%, so that only 38% of the solid bodies impinging on the proportionate radius impinge into the engine core area.

The present invention in its embodiment is not limited to the preferred embodiment example given above. Rather, a multiplicity of versions is conceivable, which make use of the solution depicted as well as embodiments that are of fundamentally differing types. Thus, cone 1 can also have multiple conical angle sections.

It will be appreciated by those skilled in the art having the benefit of this disclosure that this inlet cone for a jet engine provides an inlet cone for a jet engine in which the entry of solid bodies into the engine core area can be minimized in a checkable manner.

1-8. (canceled)

9. An inlet cone for a jet engine configured as a bypass turbojet engine, which engine has an air inlet area for receiving an air flow, an engine core area, a casing area surrounding the engine core area, and a turnably supported shaft, the inlet cone comprising:
an inlet cone surface disposed concentrically in the air inlet area and mounted on the turnably supported shaft so as to turn with the shaft;
the cone surface having a conical angle at which solid bodies impinging with the air flow onto the inlet cone ricochet off the cone in motion paths which lead a greater portion of the solid bodies into the casing area and a lesser portion of the solid bodies into the engine core area.

10. An inlet cone in accordance with claim 9, wherein the conical angle of inlet cone has a value within the range of 30° to 45°.

11. An inlet cone in accordance with claim 10, wherein the conical angle of inlet cone has a value within the range of 35° to 40°.

12. An inlet cone in accordance with claim 11, wherein the conical angle of inlet cone has a value of about 38°.

13. An inlet cone in accordance with claim 9, wherein the inlet cone is dividable in the radial direction into an inner inflow region and into an outer inflow region, and the radial boundary between the two regions is defined by a limit flow radius.

14. An inlet cone in accordance with claim 13, wherein:
the solid bodies impinging with the air flow onto the inner inflow region, after ricocheting off the inlet cone, travel via an outer motion path into the casing area; and
the solid bodies impinging with the air flow onto the outer inflow area, after ricocheting off the inlet cone, travel via an inner motion path into the engine core area.

15. An inlet cone in accordance with claim 13, wherein the limit flow radius has a radial share within the range of 50% to 70% of the outer radius of the inlet cone.

16. An inlet cone in accordance with claim 15, wherein the limit flow radius has a radial share within the range of 55% to 65% of the outer radius of inlet cone.

17. An inlet cone in accordance with claim 16, wherein the limit flow radius has a radial share of about 62% of the outer radius of inlet cone.

18. An inlet cone in accordance with claim 13, wherein the inlet cone further comprises:
an outer surface in the outer inflow region having an outer conical angle;
an inner surface in the inner inflow region having an inner conical angle, the inner conical angle being a larger conical angle than the outer conical angle, thereby forming an angular kink of the differing conical angles; and
wherein the radial location of the angular kink coincides with the limit flow radius.

19. An inlet cone in accordance with claim 9, wherein the cone extends over its entire length along a longitudinal axis of the engine with a uniform conical angle.

20. A jet engine configured as a bypass turbojet engine, comprising:
a shaft turnably supported to turn about a longitudinal axis;
an air inlet area for receiving an air flow along the longitudinal axis;
an engine core area surrounding the longitudinal axis;
a casing area surrounding the engine core area; and
an inlet cone including an inlet cone surface disposed concentrically in the air inlet area and mounted on the turnably supported shaft so as to turn with the shaft;
the cone surface being dividable in the radial direction into an inner inflow region having an inner conical angle and into an outer inflow region having an outer conical angle, the radial boundary between the two regions defining a limit flow radius; wherein
the solid bodies impinging with the air flow onto the inner flow region, after ricocheting off the inlet cone, travel via an outer motion path into the casing area; and wherein
the solid bodies impinging with the air flow onto the outer inflow area, after ricocheting off the inlet cone, travel via an inner motion path into the engine core area;
the inner and outer conical angles being selected such that a greater portion of the solid bodies impinging the cone surface travel into the casing area and a lesser portion of the solid bodies impinging the cone surface travel into the engine core area.

21. A jet engine in accordance with claim 20, wherein the inner and outer conical angles are substantially equal.

22. A jet engine in accordance with claim 21, wherein the inner and outer conical angles are both within the range of 30° to 45°.

23. A jet engine in accordance with claim 20, wherein:
the inner conical angle is greater than the outer conical angle, thereby forming an angular kink of the differing conical angles; and
the radial location of the angular kink coincides with the limit flow radius.

24. A jet engine in accordance with claim 23, wherein the inner and outer conical angles are both within the range of 30° to 45°.

25. A method of using an inlet cone for a jet engine configured as a bypass turbojet engine having an air inlet area for receiving an air flow, an engine core area, a casing area surrounding the engine core area, and a turnably supported shaft, the method comprising the steps:
mounting an inlet cone on the turnably supported shaft to turn with the shaft; and
selecting a conical angle for the surface of the inlet cone such that solid bodies impinging with the air flow onto the conical configuration ricochet from the conical configuration in motion paths which lead most of the solid bodies into the casing area.

26. A method in accordance with claim 25, wherein the conical angle of inlet cone has a value within the range of 30° to 45°.

27. A method in accordance with claim 26, wherein the inlet cone is dividable in the radial direction into an inner inflow region and into an outer inflow region, and the radial boundary between the two regions is defined by a limit flow radius.

28. A method in accordance with claim 27, wherein the inlet cone further comprises:
an outer surface in the outer inflow region having an outer conical angle;
an inner surface in the inner inflow region having an inner conical angle, the inner conical angle being a larger conical angle than the outer conical angle, thereby forming an angular kink of the differing conical angles; and
wherein the radial location of the angular kink coincides with the limit flow radius.
